(19) United States
(12) Patent Application Publication
(10) Pub. No.: US 2014/0082132 A1
(43) Pub. Date: Mar. 20, 2014

(54) TARGETED HTTP REDIRECTS

(71) Applicants: Nazar Potereyko, San Francisco, CA (US); Seth Hodgson, Oakland, CA (US); Kevin Streeter, San Bruno, CA (US)

(72) Inventors: Nazar Potereyko, San Francisco, CA (US); Seth Hodgson, Oakland, CA (US); Kevin Streeter, San Bruno, CA (US)

(73) Assignee: Adobe Systems Incorporated, San Jose, CA (US)

(21) Appl. No.: 13/619,444

(22) Filed: Sep. 14, 2012

(51) Int. Cl. G06F 15/16

(52) U.S. Cl. 709/217

(57) ABSTRACT

One exemplary embodiment involves receiving a request to access data that corresponds to a placeholder link from a requesting client device. The embodiment further involves identifying a set of recipient attributes associated with the client device. Additionally, the embodiment involves determining a plurality of sponsor links based at least in part on the recipient attributes, wherein the recipient attributes provided targeted alternative content to the client device. Then, the embodiment involves directing the client device as indicated by the identified sponsor links.

### FIELD

This disclosure relates generally to computer software and more particularly relates to the creation, modification, use, and distribution of electronic content.

### BACKGROUND

Streaming media content such as sporting events, television shows, or movies via certain existing streaming technologies involves providing a manifest file to a client device. The manifest file includes a number of references referred to as “links” that correspond to different portions or features of the media content. For example, the links may be hypertext transfer protocol (HTTP) links that may be sequentially invoked via a browser or other content player on the client device to access sequential time segments of the streaming media content, e.g., the first 30 seconds, the following 30 seconds, and so on. The client device caches the manifest file upon receipt and processes the links sequentially to render the media content. A browser or other media player may thus render the streaming media content on a display by accessing the content corresponding to each of the links found in the manifest file.

Streaming media content is generally distributed by such methods in a manner such that all recipients of the content receive the same content. More specifically, recipients all receive the same manifest file and invoke the same portions or features of the media content. Thus, if advertisements are inserted into a baseball broadcast (e.g., via links to advertisements in the manifest file), all recipients of the baseball game broadcast are subject to viewing the same advertisement. Personalizing the manifest file for particular users has not considered been feasible or scalable. Therefore, existing technologies fail to provide acceptable techniques for distributing personalized and scalable streaming media content and suffer from other deficiencies.

### SUMMARY

One exemplary embodiment includes a redirect service that provides targeted alternative content to a client device accessing streaming content. The redirect service receives a request to access data that corresponds to a link and identifies a set of recipient attributes associated with a client device that originated the request. The redirect service then determines which one of a plurality of sponsor links to direct the client device, the sponsor links being determined based at least in part on the recipient attributes. The redirect service then directs the client device to the sponsor link that corresponds to the targeted alternative content.

These illustrative features are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting exemplary computing devices in an exemplary computing environment for implementing certain embodiments;

FIG. 2 is a flow chart illustrating an exemplary method of content publishing involving receiving a request for consuming content and providing a content playlist that corresponds to the requested content;

FIG. 3 is a flow chart illustrating an exemplary redirect method involving receiving a request to access data corresponding to a placeholder link and providing personalized alternative content as indicated by a sponsor; and

FIG. 4 is a flow chart illustrating another exemplary method of rendering streaming content and personalized alternative content.

### DETAILED DESCRIPTION

Disclosed are embodiments for personalizing a manifest file to provide targeted streaming content. Targeted advertisements and other alternative content can be provided to users that request to consume the streaming content. In particular, the targeted alternative content may be personalized for each user based on a set of attributes associated with the user and the client device of the user. In one embodiment, a publisher server device that provides the streaming content generates a manifest file that includes a number of content links and a number of placeholder links. Each one of the content links corresponds to a portion of the requested content. Each one of the placeholder links serves as placeholder for providing the targeted alternative content to the users. A content publishing service implemented on a publisher server device receives a request from a client device and, in response, provides a manifest file that includes the content links and the placeholder links. A client side application processes the manifest file by invoking the content links and the placeholder links as indicated in the manifest file. For example, a browser may invoke the links sequentially and renders the streaming content on a display associated with the client device. Invoking a content link transmits a request to the publisher server device to provide the portion of the content that corresponds with the content link.

Invoking a placeholder link directs the client device to a redirect server device. A redirect service being implemented on the redirect server device receives the request to access data that corresponds with the placeholder link and redirects the request to a sponsor link, such as a link to a particular advertisement targeted to the particular content recipient. In one embodiment, the redirect service redirects the client device to a sponsor link based at least in part on a set of recipient attributes such as hardware and/or software characteristics associated with the client device or user attributes associated with the user operating the client device. For example, a sponsor may have previously provided associations between recipient attributes and sponsor links. Certain sponsor links may be provided for client devices that are associated with predefined hardware characteristics and/or software characteristics. Additionally, certain sponsor links may be provided for users on client devices that are associated with predetermined geographic and demographic data. In another embodiment, the redirect service redirects the client device to a sponsor link based at least in part on the content being consumed by the client device. For example, the placeholder link may identify the content being consumed and the client device may be redirect to alternative content related to the content being consumed.

To this end, the redirect service may receive the recipient attributes from the client device. For example, the redirect service may receive device characteristics associated with the client device and user attributes associated with the user operating the client device. The redirect service determines which sponsor links correspond to the received recipient attributes and provides the determined sponsor links to the requesting client device. In one embodiment, the redirect service redirects the client device to the location indicated by the determined sponsor links. For example, the determined sponsor link may present an advertisement targeted specifically for the user operating the client device based on demographic data and/or other personalized information associated with the user.

Applying certain of the techniques described herein allows for a scalable and personalized approach for providing streaming content on a large scale that includes personalized and targeted alternative content for each individual user. A single manifest file may be generated for the content that can be cached within the HTTP infrastructure. For example, the manifest file may be marked as cachable using standard means as defined by HTTP and thus any one of the HTTP nodes in the network 113 can cache the manifest file by following one or more of standard HTTP caching rules, as known in the art. The manifest file may then be provided to all users that request to consume the content. Additionally, the single manifest file may also provide for personalized and targeted alternative content by including placeholder links within the manifest file. When the client device transmits a request to access data that corresponds to the placeholder link, the redirect service redirects the client device to the targeted alternative content.

These illustrative examples are given to introduce the reader to the general subject matter discussed here and are not intended to limit the scope of the disclosed concepts. The following sections describe various additional embodiments and examples with reference to the drawings in which like numerals indicate like elements.

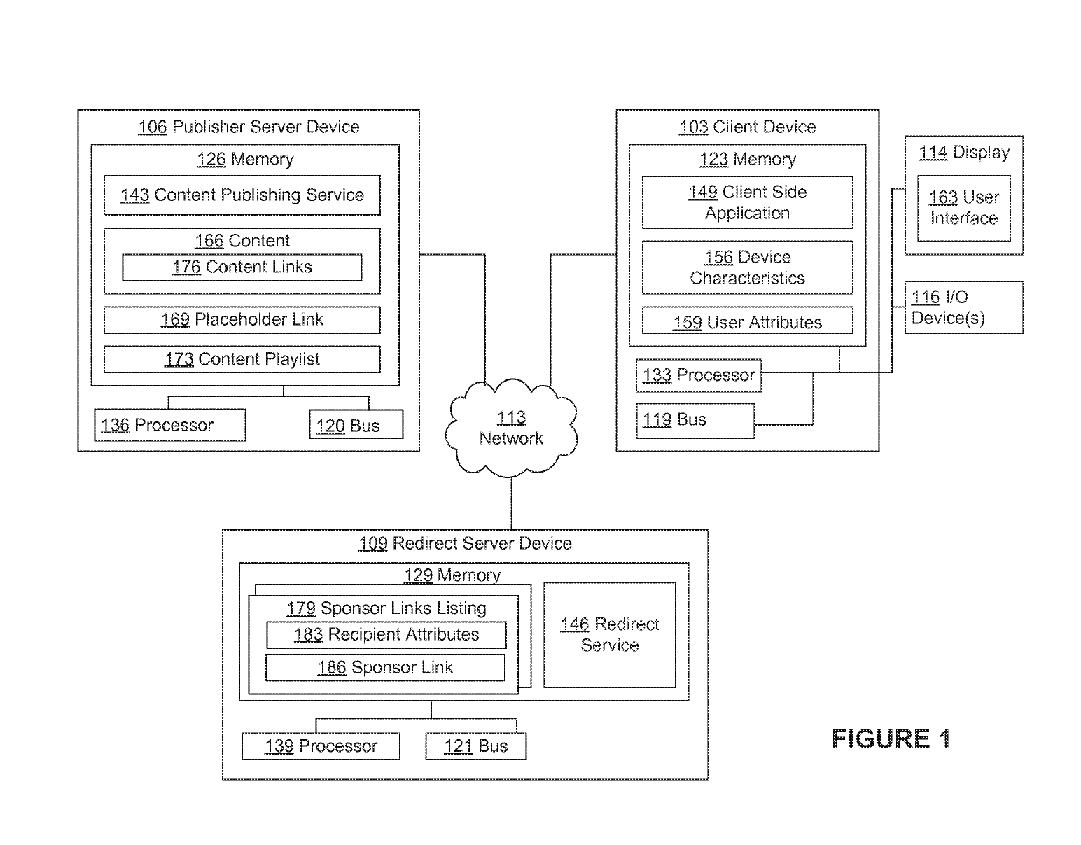

FIG. 1 depicts an exemplary computing environment for performing searches based on search criteria as described herein. The methods and systems disclosed herein are also applicable on other computing systems and environments. The environment shown in FIG. 1 includes a wired or wireless network 113 connecting various devices 103, 106, and 109. In one embodiment, the network 113 includes the Internet. In other embodiments, other networks, intranets, or combinations of networks may be used. Alternative configurations are possible.

As used herein, the term “device” refers to any computing or other electronic equipment that executes instructions and includes any type of processor-based equipment that operates an operating system or otherwise executes instructions. A device will typically include a processor that executes program instructions and may include external or internal components such as a mouse, a CD-ROM, DVD, a keyboard, a display, or other input or output equipment. Examples of devices are personal computers, digital assistants, personal digital assistants, cellular phones, mobile phones, smart phones, pagers, digital tablets, laptop computers, Internet appliances, other processor-based devices, and television viewing devices. Exemplary devices 103 and 106 are respectively used as special purpose computing devices to provide specific functionality offered by their respective applications and by the interaction between their applications. As an example, client device 103 is shown with a display 114 and various input/output devices 116. A bus, such as bus 119, bus 120, and bus 121 will typically be included in a device as well.

As used herein, the term “application” refers to any program instructions or other functional components that execute on a device. An application may reside in the memory of a device that executes the application. As is known to one of skill in the art, such applications may be resident in any suitable computer-readable medium and execute on any suitable processor. For example, as shown the devices 103, 106, and 109 each have a computer-readable medium such as memory 123, 126 and 129 coupled to a processors 133, 136, and 139 that execute computer-executable program instructions and/or accesses stored information. Such processors 133, 136 and 139 may comprise a microprocessor, an ASIC, a state machine, or other processor, and can be any of a number of computer processors. Such processors include, or may be in communication with, a computer-readable medium which stores instructions that, when executed by the processor, cause the processor to perform the steps described herein.

As used herein, the term “server” refers to an application that listens for or otherwise waits for requests or a device that provides one or more such applications that listens for or otherwise waits for requests. Publisher server device 106 and sponsor service device 109 are examples of a server. A “server device” may be used to perform the searching of items based on a received search criteria from the user. For example, the publisher server device 106 may include a content publishing service 143 and the sponsor service device 109 may include a redirect service 146.

A computer-readable medium may include, but is not limited to, an electronic, optical, magnetic, or other storage device capable of providing a processor with computer-readable instructions. Other examples include, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

In FIG. 1, client device 103 includes a memory 123 that includes a client side application 149, a listing of device characteristics 156, and a listing of user attributes 159. The client side application 149 may be a browser that renders a user interface 163 on the display 114. In one embodiment, the device characteristics 156 may include a listing of hardware and/or software characteristics associated with the device. For example, the device characteristics 156 include information related to the processor 133, information related to the memory 123, information related to the display 114, an amount of hard drive space, an amount of memory space, and/or other information related to computing capability of the client device 103. Additionally, the device characteristics 156 may also include information related to the type and version of the applications implemented on the client device 103, a type of operating system, and/or any other software related information. The user attributes 159 may include a listing of attributes associated with the user operating the client device 103. For example, the user attributes 159 may include geographical information, demographic information, browsing preferences, purchasing preferences, and/or other information describing a pattern of behavior of the user.

The publisher server device 106 includes a memory 126 that includes a content publishing service 143, content 166, a placeholder link 169, and content playlist 173. The content publishing service 143 receives a request to access the content 166 from one or more client devices 103. In response, the content publishing service 143 provides the content playlist 173 (generating the content playlist 173 if it has not already been generated) that includes a number of content links 176 and one or more placeholder links 169. In one embodiment, each content link 176 corresponds to a portion of the content 166 requested by the client device 103. For instance, the content 166 may be media such as music, movies, documentaries, television shows, and/or any other type of media. Additionally, the content 166 may be a live broadcast and/or a recording. In one embodiment, the content playlist 173 may be generated such that each of the content links 176 may be sequentially invoked on the client device 103 resulting in the portion of the content 166 that corresponds to the invoked content link 176 to be transmitted for consumption to the client device 103. Additionally, the content playlist 173 may also be configured such that the placeholder links 169 are also sequentially invoked on the client device 103. The placeholder links 169 may also identify the content 166 being provided via the content playlist 173. For example, a content identifier may be included in the metadata of the placeholder link 169 that uniquely identifies the content 166. In one embodiment, the client device 103 may be directed to the redirect server device 109 when the placeholder link 169 is invoked.

The redirect server device 109 includes a memory 129 that includes a listing of sponsor links 179 and the redirect service 146. In one embodiment, the listing of sponsor links 179 includes a number of sponsor links 186 that are each associated with a set of recipient attributes 183. Each sponsor link 186 may correspond to content provided by a sponsor such as, for example, an advertisement, supplemental content, or the like. Additionally, the sponsor may also indicate a set of recipient attributes 183 for redirecting the client device 103 to the provided sponsor link 186. For example, the sponsor may indicate to redirect the client device 103 if the user operating the client device 103 and/or the client device 103 match the set of recipient attributes 183. In one embodiment, the recipient attributes 183 may be related to regional information, device information, demographic information, and/or any other recipient specific information. The redirect service 146 receives a request for access by the client device 103 when a placeholder link 169 is invoked. In response, the redirect service 146 redirects the client device 103 to a sponsor link 186 based on the recipient attributes 183. In another embodiment, the redirect service 146 also redirect the client device 103 to a sponsor link 186 based on the content 166 associated with the content playlist 173.

In one embodiment, a user operating the client side application 149 may manipulate the user interface 163 rendered on the display 114 via the I/O devices 116 to access and browse content 166 provided by the publisher service device 106. For instance, the user may wish to access content 166 such as a live broadcast sporting event, a previously broadcasted television show, and/or other media 166. The client side application 149 may receive one or more inputs indicated by the user, such as for example a mouse click and/or a key stroke, that indicates a request for accessing the content 166 and transmit the request to the content publishing service 143.

The content publishing service 143 may receive the request and in response, provide a content playlist 173 that includes a number of content links 176 and a number of placeholder links 169. The content links 176 correspond to a portion of the content 166. For instance, the content 166 may be previously separated and/or divided into multiple portions based on time, plot, and/or other characteristic of the subject matter of the content 166. Each of the content links 176 may correspond to a respective one of the portions of the content 166. In one embodiment, each content 166 may be associated with a collection of content links 176. Invoking one of the content links 176 may provide access to the respective portion of the content 166. For example, each content link 176 may be a uniform resource locator (URL) and/or some other link. When the content link 176 is invoked on the client device 103, the corresponding portion of the content 166 may be provided to the client device 103 which can then be rendered on the display 114.

To generate the content playlist 173, the content publishing service 143 may place the content links 176 in order such that the requested content 166 is rendered sequentially on the display 114. Additionally, the content publishing service 143 may insert one or more placeholder links 169 amongst the content links 176 that form the content playlist 173. For example, the content publishing service 143 may insert the placeholder links 169 randomly or periodically amongst the content links 176. In another embodiment, the content publishing service 143 may insert the placeholder links 169 to provide for a predetermined amount of sponsored content during the playback of the requested content 166. For example, the content publishing service 143 may provide for a number of periods of sponsored content during the playback of the requested content 166. Each of the periods may be of a certain duration, such as, for instance, one minute. Each placeholder link 169 may correspond to a predetermined amount of time, such as, for example, 10 seconds. Accordingly, the content publishing service 143 may insert a block of six placeholder links 169 sequentially within the content playlist 173 to provide for a one-minute period of sponsored content. The content publishing service 143 may further place additional blocks of six placeholder links 169 within in the content playlist 173 to provide for additional periods of sponsored content of a one-minute duration.

In one embodiment, the number of placeholder links 169 to insert in the content playlist 173 may correspond to the duration of the request content 166. For example, a longer duration of the requested content 166 may correspond to a higher number of placeholder links 169. Additionally, the number of placeholder links 169 to insert in the content playlist 173 may also correspond to the amount of time associated with each placeholder link 169. For example, a longer duration of the time associated with each placeholder link 169 may correspond to a higher number of placeholder links 169 in the content playlist 173. Additionally, the content playlist 173 may be generated using a similar technique regardless of the client device 103 and/or the user operating the client device 103.

Upon generating the content playlist 173, the content publishing service 143 provides the content playlist 173 to the requesting client device 103. In one embodiment, the client side application 149 processes the content links 176 and the placeholder links 169 as listed in the content playlist 173. For example, the client side application 149 processes the links in order according to the content playlist 173. Processing a content link 176 may direct the client device 103 to a server device, such as the publisher server device 106, which serves up and/or provides the portion of the requested content 166 that corresponds to the processed content link 176. The client side application 149 may then play back the portion of the requested content 166 and render that portion on the display 114. Upon termination of the playback of the portion of the requested content 166, the client side application 149 advances to the next link in the content playlist 173. In one embodiment, the client side application 149 may process the next link prior to termination of current portion of the requested content 166 to overcome any delays and/or lags, as can be appreciated.

When the next link in the content playlist 173 is a placeholder link 169, the client device 103 is directed to the redirect server device 109. For example, the client side application 149 transmits a request to access data that corresponds to the placeholder link 169 to the redirect server device 109. The redirect service 146 receives the request and in response, provides one or more sponsor links 186 to the client side application 149. In one embodiment, the redirect service 146 provides a sponsor link 186 to the client side application 149 based on a set of recipient attributes 183 associated with the client device 103 and the user operating the client device 103. For example, the recipient attributes 183 may correspond to regional information, device information, demographic information, and/or any other recipient specific information, as discussed above. In one embodiment, the recipient attributes 183 may be determined from the device characteristics 156 of the client device 103 and the user attributes 159 of the user operating the client device 103.

To this end, the redirect service 146 may transmit a request to the client side application 149 to receive access to the device characteristics 156 and the user attributes 159. In another embodiment, the client side application 149 may transmit the device characteristics 156 and the user attributes 159 in conjunction with the request to access the data that corresponds to the placeholder link 169. In another embodiment, the redirect service 146 may determine the device characteristics 156 and the user attributes 159 from one or more header files associated with the request to access the data that corresponds to the placeholder link 169. Similarly, the redirect service 146 may determine the device characteristics 156 and the user attributes 159 from one or more cookies stored on the client device 103. In another embodiment, a user on the client device 103 may be required to log in to a previously initiated user account for accessing the content 166 via the content publishing service 143. The user may be prompted to provide user attributes 159 at the time of initialization that is then associated with the user in the memory 126 of the publisher server device 106. Additionally, the content publishing service 143 may also determine the device characteristics 156 of the client device 103 during the time of initialization, as described above. In this embodiment, the redirect service 146 may transmit a request to the content publishing service 143 to receive the user attributes 159 and the device characteristics 156 associated with the requesting user.

In one embodiment, a sponsor may have previously provided the listing of sponsor links 179 that indicates the set of recipient attributes 183 which are associated with each sponsor link 186. For example, the sponsor may have previously specified that a sponsor link 179 that corresponds to a sponsor advertisement may be associated with recipient attributes 183 that relates to demographic data of the user operating the client device 103, the geographic region associated with the client device 103, the hardware characteristics of the client device 103, software characteristics of the client device 103, and/or other attributes. To this end, the redirect service 146 may determine recipient attributes 183 from the device characteristics 156 and the user attributes 159. For example, the redirect service 146 may identify the demographic data of the user operating the client device 103 from the user attributes 159. The redirect service 146 may also identify the geographic region associated with the client device 103 from the device characteristics 156 and/or the user attributes 159. Additionally, the redirect service 146 may identify the hardware and software characteristics of the client device 103 from the device characteristics 156.

Having determined the recipient attributes 183, the redirect service 146 then provides the sponsor link 186 that corresponds to the identified recipient attributes 183. For example, the redirect service 146 may determine that the client device 103 that was directed to the redirect server device 109 includes a certain amount of hardware resources and implements a certain type of operating system. The redirect service 146 determines the sponsor link 186 that correspond to these recipient attributes 183 of the client device 103 and provides that sponsor link 186 to the client device 103. Similarly, the redirect service 146 may determine that the user operating the client device 103 may be within a certain age range and earn a certain amount of annual salary. The redirect service 146 determines the sponsor link 186 that correspond to these recipient attributes 183 of the client device 103 and provides that sponsor link 186 to the client device 103.

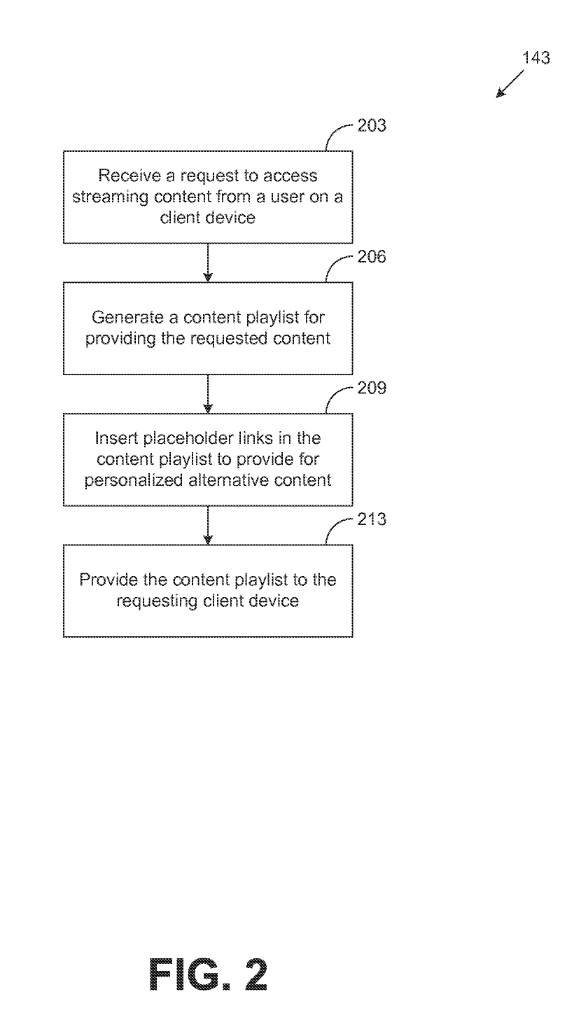

FIG. 2 is a flowchart that provides one example of the operation of a portion of the content publishing service 143 according to certain embodiments. It is understood that the flowchart of FIG. 2 provides merely an example of the many different types of functional arrangements that may be employed to implement the operation of the portion of the content publishing service 143 as described herein. As an alternative, the flowchart of FIG. 2 may be viewed as depicting an example of steps of a method implemented in the publisher server device 106 (FIG. 1) according to one or more embodiments.

Beginning with step 203, the content publishing service 143 receives a request to access streaming content 166 (FIG. 1) from a user operating a client device 103 (FIG. 1). For example, the streaming content 166 may be live broadcast media such as sporting events, concerts, news, and/or other media. The streaming content 166 may also be recorded media such as television shows, movies, documentaries, and/or other media.

In step 206, the content publishing service 143 generates a content playlist 173 (FIG. 1) for providing the requested content 166. In one embodiment, the content playlist 173 includes a number of HTTP links such as content links 176 (FIG. 1) and placeholder links 169 (FIG. 1). Each one of the content links 176 may correspond to a portion of the requested content. For instance, the requested content 166 may have been previously divided and/or separated into multiple portions based on time, the subject matter of the content 166, and/or other criteria. The content publishing service 143 may generate the content playlist 173 such that the order of the content links 176 corresponds to a sequential playback of the requested content 166 when the content links 176 are invoked on the client device 103.

Then, in step 209, the content publishing service 143 inserts a number of placeholder links 169 within the content playlist 173. In one embodiment, invoking the placeholder links 169 on the client device 103 directs the client device 103 to a redirect server device 109 (FIG. 1) that may then provide personalized alternative content. The content publishing service 143 may insert the placeholder links 169 randomly or periodically within the content playlist 173. Additionally, the number of placeholder links 169 inserted into the content playlist 173 may be based on a desired duration of the personalized alternative content to be provided to the user on the client device. For example, inserting a higher number of placeholder links 169 may result in a larger amount of personalized alternative content that his provided to the user.

In step 213, the content publishing service 143 provides the content playlist 173 to the requesting client device 103. In one embodiment, the content publishing service 143 may also receive a request to provide a portion of the requested content 166 when the corresponding content link 176 is invoked on the client device. In response, the content publishing service 143 provides the respective portion of the requested content 166.

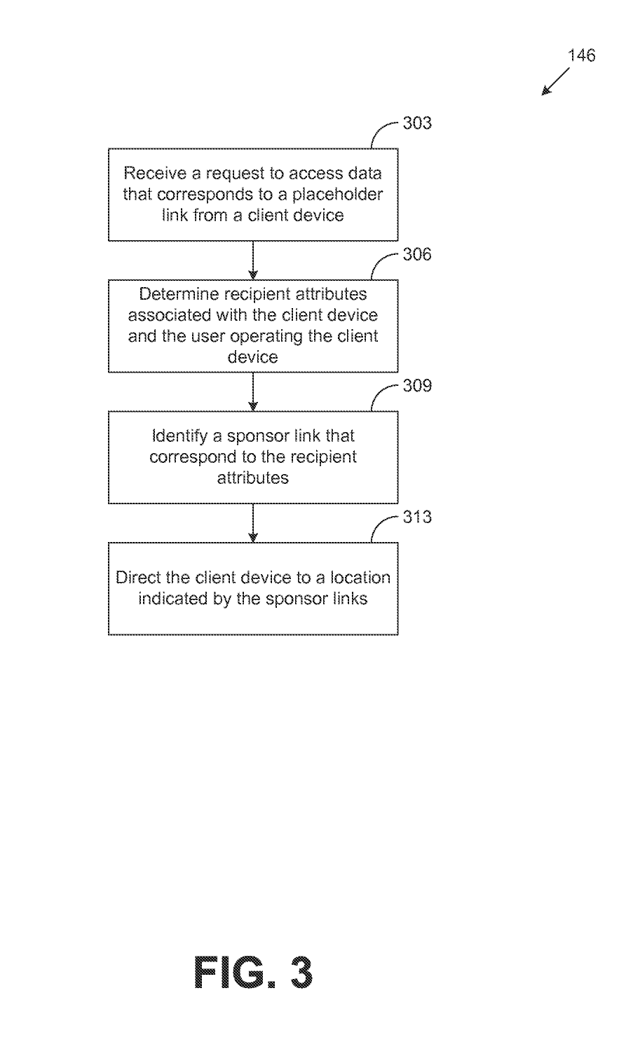

FIG. 3 is a flowchart that provides one example of the operation of a portion of the redirect service 146 according to certain embodiments. It is understood that the flowchart of FIG. 3 provides merely an example of the many different types of functional arrangements that may be employed to implement the operation of the portion of the redirect service 146 as described herein. As an alternative, the flowchart of FIG. 3 may be viewed as depicting an example of steps of a method implemented in the redirect server device 109 (FIG. 1) according to one or more embodiments.

Beginning with step 303, the redirect service 146 receives a request to access data that corresponds to a placeholder link 169 from a client device 103. In one embodiment, the client side application 149 processing the content playlist 173 provided by a content publishing service 143 invokes the placeholder link 169 as indicated in the content playlist 173. The client device 103 may then be directed to the redirect service 146.

Then, in step 306, the redirect service 146 determines the set of recipient attributes 183 associated with the client device 103 and the user operating the client device 103. The recipient attributes 183 may correspond to hardware and software attributes of the client device 103, geographic information associated with the client device 103, behavioral information associated with the user, and/or other attributes as discussed above. In one embodiment, the redirect service 146 may receive the device characteristics 156 associated with the client device 103 and the user attributes 159 associated with the user operating the client device 103 in conjunction with the request to access the data that corresponds to the placeholder link 169. In another embodiment, the redirect service 146 may transmit a request to receive the device characteristics 156 and the user attributes 159 in response to receiving the request to access the data that corresponds to the placeholder link 169.

In step 309, the redirect service 146 identifies a sponsor link 186 that corresponds to the recipient attributes 183. In one embodiment, the redirect service 146 determines whether the received device characteristics 156 and user attributes 159 correspond to at least a portion of one of the sets of the recipient attributes 183 provided by a sponsor. For example, the recipient attributes 183 associated with a sponsor link 186 may indicate that the client device 103 have a certain amount of computing resources and be implementing a certain version of an operating system. The redirect service 146 may determine whether the device characteristics 156 of the client device 103 correspond to these recipient attributes 183 and if there is a correspondence, the redirect service may determine to provide the sponsor link 186 to the client device 103. Similarly, the recipient attributes 183 associated with a sponsor link 186 may indicate that the user operating the client device 103 be classified under a certain demographic bucket. The redirect service 146 may determine whether the user attributes 159 of the user correspond to these recipient attributes 183 and if there is a correspondence, the redirect service may determine to provide the sponsor link 186 to the client device 103.

In step 313, the redirect service 146 directs the client device 103 to a location as indicated by the identified sponsor link 186. For example, the sponsor link 186 may be a HTTP link to which the redirect service 146 directs the client device 103. In one embodiment, the sponsor link 186 may provide personalized alternative content to the user operating the client device 103. Using the above examples, the sponsor link 186 may provide content that requires a certain amount of computing resources for a client device 103 to consume, such as, for example a high definition media file. Additionally, the sponsor link 186 may provide content that is targeted towards a certain gender within an age group, such as, for example an advertisement for goods and/or services.

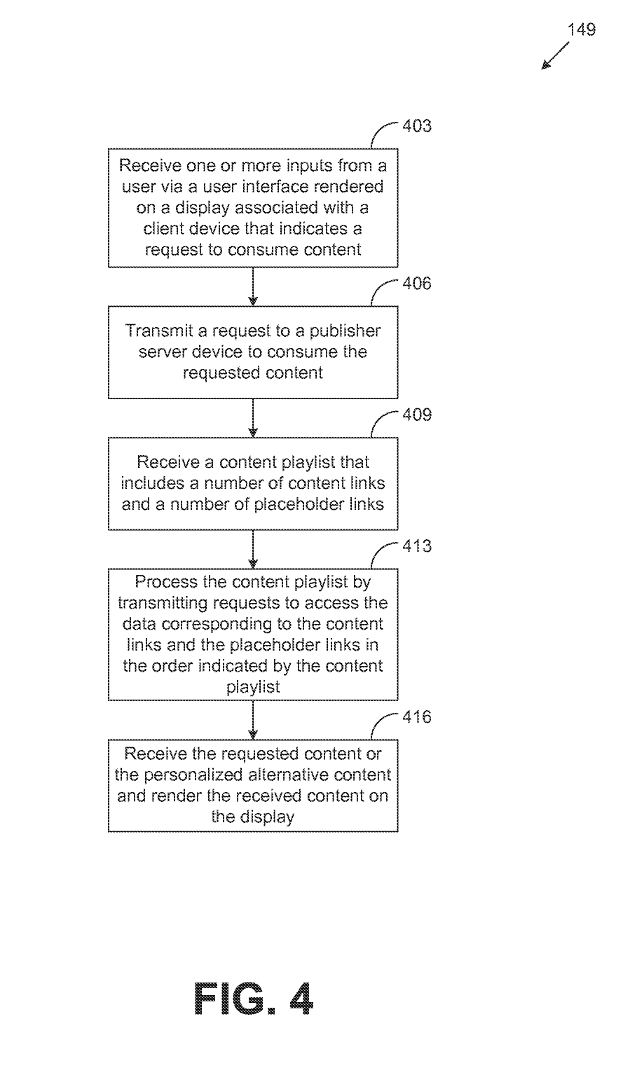

FIG. 4 is a flowchart that provides one example of the operation of a portion of the client side application 149 according to certain embodiments. It is understood that the flowchart of FIG. 4 provides merely an example of the many different types of functional arrangements that may be employed to implement the operation of the portion of the client side application 149 as described herein. As an alternative, the flowchart of FIG. 4 may be viewed as depicting an example of steps of a method implemented in the client device 103 (FIG. 1) according to one or more embodiments.

Beginning with step 403, the client side application 149 receives one or more inputs from a user operating the client device 103 via a user interface 163 (FIG. 1) that indicates a request to consume content 166 (FIG. 1). For example, the user many manipulate one or more components of the user interface 163 via I/O devices 116 (FIG. 1) associated with the client device 103. Then, in step 406, the client side application 149 may transmit the request to consume the content 166 to the publisher server device 106 (FIG. 1) via the network 113 (FIG. 1). In one embodiment, the content publishing service 143 may receive the request to consume the content 166.

In step 409, the client side application 149 receives a content playlist 173 generated by the content publishing service 143 that includes a number of content links 176 (FIG. 1) and a number of placeholder links 169 (FIG. 1). In one embodiment, the content playlist 173 may include a number of content links 176 that each correspond to a portion of the requested content 166. For example, the content links 176 may be HTTP links that may be invoked via a browser and/or the client side application 149. The client side application 149 may transmit a request to the publisher server device 106 and/or some other device as indicated by the HTTP link to receive access to the content 166. Additionally, the content playlist 173 may include a number of placeholder links 169 that represent a placeholder for providing personalized content.

In step 413, the client side application 149 processes the content playlist 173 by transmitting requests to access the data corresponding to the content links 176 and the placeholder links 169 in the order indicated by the content playlist 173. In one embodiment, the client side application 149 may be directed to the publisher server device 106 to transmit a request to access the data that corresponds to the content link 176. Then, in step 416, the client side application 149 receives a portion of the requested content 166 that corresponds to the content link 176.

Returning to step 413, the client side application 149 may be directed to the redirect server device 109 to transmit a request to access the content that corresponds to the placeholder link 169. The redirect service 146 (FIG. 1) may receive the request and direct the client device 103 to a location specified by a sponsor link 186. In one embodiment, the redirect service 146 determines the sponsor link 186 based at least in part on a set of recipient attributes 183 associated with the client device 103 and the user operating the client device 103. For example, the redirect service 146 may determine the recipient attributes 183 based at least in part on the device characteristics 156 (FIG. 1) of the client device 103 and the user attributes 159 (FIG. 1) of the user operating the client device 103. In one embodiment, the client side application 149 may receive a request from the redirect service 146 to provide the device characteristics 156 and the user attributes 159. The client side application 149 may then be directed to a location specified by a sponsor link 186 where the sponsor link 186 is selected based on the recipient attributes 183. In one embodiment, the sponsor link 186 may provide targeted and personalized alternative content that may be rendered by the client side application 149 on the display 114 of the client device 103.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
receiving a request to access data that corresponds to a link, the request originating from a client device that obtained the link from a content playlist for media streaming content to be received at the client device;
identifying, by a processor, a recipient attribute associated with the request;
determining, by the processor, one of a plurality of sponsor links with which to redirect the request, the sponsor links being determined based at least in part on the recipient attribute; and
redirecting the request based on the determined sponsor link.

2. The method of claim 1, wherein determining the sponsor link comprises identifying that the sponsor link corresponds to the recipient attribute.

3. The method of claim 1, wherein the recipient attribute comprises at least one of:
a geographic region associated with the client device;
a hardware characteristic associated with the client device; and
a software characteristic associated with the client device.

4. The method of claim 1, wherein the recipient attribute comprises demographic data associated with a recipient operating the client device to receive the media streaming content.

5. The method of claim 1, wherein the link is a placeholder link identifying an identity of the media streaming content and linking to a redirect service, wherein a request based on the placeholder link to the redirect service is redirected to personalized content based at least in part on the identity of the media streaming content.

6. The method of claim 1, wherein redirecting the request comprises responding to the request by providing the sponsor link to the client device to allow the client device to obtain a content item to be included in the media streaming content.

7. The method of claim 1, wherein the content playlist comprises a plurality of content links and a plurality of placeholder links, the content links linking directly to content items and the placeholder links linking to a redirect service redirecting requests to personalized content items.

8. The method of claim 7, wherein the content playlist includes a plurality of placeholder links appearing on a periodic basis.

9. The method of claim 7, wherein each one of the content links corresponds to a different portion of the content provided by a publisher.

10. The method of claim 1, wherein the sponsor link is determined to correspond to targeted content for at least one of the client device and a recipient operating the client device.

11. A system comprising:
a processor for executing instructions stored in computer-readable medium on one or more devices,
the application comprising one or more modules configured to perform the steps comprising:
identifying a plurality of content links associated with content;
generating a content playlist comprising the content links and a plurality of placeholder links, the content links linking directly to content items and the placeholder links linking to a redirect service redirecting requests to personalized content items; and
in response to receiving, from a requesting service, a request to access content, providing the content playlist to the requesting service.

12. The system of claim 11, wherein each one of the content links correspond to a portion of the requested content.

13. The system of claim 11, wherein the sponsor server device points the requesting service to a sponsor link that provides targeted content.

14. The system of claim 13, wherein the sponsor link is identified based on a set of attributes associated with the requesting service.

15. The system of claim 11, wherein generating the content playlist comprises:
determining a period of time in which to provide targeted content; and
inserting a number of placeholder links in the content playlist, wherein the number of placeholder links corresponds to the period of time.

16. A non-transitory computer-readable medium on which is encoded program code, the program code comprising:
transmitting, from a client device, a request to access content;
receiving a content playlist that comprises a plurality of content links and a plurality of placeholder links, each of the content links corresponding to a respective portion of the content;
invoking the content links and the placeholder links in an order indicated by the content playlist.

17. The non-transitory computer-readable medium of claim 16, wherein invoking the content links comprises:
transmitting a request to access the portion of the content that corresponds to each one of the content links;
receiving the respective portion of the content; and
rendering the portion of the content on a display.

18. The non-transitory computer-readable medium of claim 16, wherein invoking the placeholder links comprises:
transmitting a request to access data that corresponds to each one of the placeholder links;
receiving a request to access at least one of a set of device characteristics associated with the client device and a set of user attributes associated with a user operating the client device;
transmitting the at least one of device characteristics and user attributes; and
receiving targeted alternative content based at least in part on the at least one of device characteristics and user attributes.

19. The non-transitory computer-readable medium of claim 16, wherein the content links and placeholder links are Hypertext Transfer Protocol Links.

20. The non-transitory computer-readable medium of claim 18, wherein the targeted alternative content is an advertisement.
